(19) United States
(12) Patent Application Publication
(10) Pub. No.: US 2026/0026602 A1
(43) Pub. Date: Jan. 29, 2026

(54) KINETICALLY INDUCED WRIST BRACELET WITH HOLDER

(71) Applicant: Dawn Benefield, Punta Gorda, FL (US)

(72) Inventor: Dawn Benefield, Punta Gorda, FL (US)

(21) Appl. No.: 19/279,631

(22) Filed: Jul. 24, 2025

Related U.S. Application Data
(60) Provisional application No. 63/675,216, filed on Jul. 24, 2024.

(51) Int. Cl. A45F 5/00; A61C 19/00

(52) U.S. Cl. CPC A45F 5/00; A61C 19/006; A45F 2005/008

(57) ABSTRACT

A kinetically induced wrist bracelet with holder that includes a unitary body defining a body length separating the ends thereon, having an inner core of an arcuate shape spanning along the body length, having an outer layer surrounding the inner core and spanning along the body length, having at least one holder sidewall directly coupled to the outer layer and disposed in an erect configuration relative to the outer layer to define a cavity shaped and sized to receive a selectively removable container therein, and operably configured with an impetus to have a first position of a linear orientation including the at least one holder sidewall projecting outwardly from a concave surface on the arcuate shape of outer layer and have a second position of an annular orientation including the at least one holder sidewall projecting outwardly from a convex surface on the arcuate shape of the outer layer.

### FIELD OF THE INVENTION

The present invention relates generally to wrist bracelets and, more particularly, relates to bracelets for receiving and holding contents therein while being worn by the user.

### BACKGROUND OF THE INVENTION

Many professionals require the use of external objects, like tools, liquids, and portable containers for their work. This is particularly true in the dental industry where dental hygienists and other professions desire and/or require the need for applying prophylaxis paste or other similar material on a patient in an effective, safe, and effective manner. For example, many dental professionals are required to apply the prophylaxis paste (which conventionally is sold in small containers designed for a single one-time patient use) by holding the paste and/or container in one of their hands, which minimizes the effectiveness of utilizing the tool. In some instances, the prophylaxis container is inadvertently knocked over and/or spilled, wasting time and money.

Some known methods and products that help professionals carry and/or hold external objects include apparel items, like belts, necklaces, vests, etc., but these products are not as efficiently worn and/or utilized as desired by many users. To that end, many of these known items are not conducive to repeated use by the user and/or often not routinely utilized by users.

Therefore, a need exists to overcome the problems with the prior art as discussed above.

### SUMMARY OF THE INVENTION

The invention provides a structure and method of applying and removing a kinetically induced bracelet with holder on a user that overcomes the hereinafore-mentioned disadvantages of the heretofore-known devices and methods of this general type and that enables selective, safe, and efficient application and removal of the bracelet on a user while providing a user the ability to retain or hold contents the user requires or desires to carry out their desired task.

With the foregoing and other objects in view, there is provided, in accordance with the invention, a kinetically induced bracelet with holder that includes a unitary body having a first end, having a second end opposing the first end, defining a body length separating the first and second ends, having an inner core of an arcuate shape spanning along the body length, having an outer layer surrounding the inner core, forming an arcuate shape, and spanning along the body length, having at least one holder sidewall directly coupled to the outer layer and disposed in an erect configuration relative to the outer layer to define a cavity shaped and sized to receive a selectively removable container therein, and operably configured with an impetus to have a first position of a linear orientation including the at least one holder sidewall projecting outwardly from a concave surface on the arcuate shape of outer layer and have a second position of an annular orientation including the at least one holder sidewall projecting outwardly from a convex surface on the arcuate shape of the outer layer.

In accordance with a further feature of the present invention, the accurate inner core spans at least 90% of the body length. Also, the outer layer may encapsulate the inner core and be made completely or partially of a polymeric material. The outer layer and holder sidewall may also be over-molded onto the inner core. Further, the inner core may also be of a monolithic and continuous metallic material formed in a narrow configuration.

In accordance with yet another feature of the present invention, the at least one holder sidewall is disposed in a substantially perpendicular configuration (+/−) 5° relative to the outer layer. Additionally, the at least one holder sidewall is enclosed to surround the cavity and the outer layer and the at least one sidewall are of a polymeric elastic material. Further, the outer layer may also encapsulate the inner core. Additionally, the outer layer and holder sidewall may also be over-molded onto the inner core.

In accordance with an exemplary feature of the present invention, the erect configuration of the at least one holder sidewall defines a holder height ranging from 0.25-1 in., wherein the at least one holder sidewall encloses the cavity. The cavity may also define a diameter ranging from 0.25-1 in.

In accordance with yet another feature of the present invention, two holder sidewalls are coupled to the outer surface in an adjacent configuration and spaced apart from one another within lin.

Although the invention is illustrated and described herein as embodied in a kinetically induced bracelet with holder, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

Before the present invention is disclosed and described, it is to be understood that the terminology used herein is for the purpose of describing particular embodiments only and is not intended to be limiting. The terms “a” or “an,” as used herein, are defined as one or more than one, wherein the utilization of “a” or “an” does not mean multiple structures with various functions may be utilized to equate to single claimed structure with claimed functionality. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time. Also, for purposes of description herein, the terms “upper”, “lower”, “left,” “rear,” “right,” “front,” “vertical,” “horizontal,” and derivatives thereof relate to the invention as oriented in the figures and is not to be construed as limiting any feature to be a particular orientation, as said orientation may be changed based on the user's perspective of the device. Furthermore, there is no intention to be bound by any expressed or implied theory presented in the preceding technical field, background, brief summary or the following detailed description.

As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. In this document, the term “longitudinal” should be understood to mean in a direction corresponding to an elongated direction of the containers, straw member, and/or, where applicable, a direction where a length of an object is greater than the diameter or width of that same object.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present invention.

FIG. 1 depicts a perspective, partially transparent, view of a kinetically induced bracelet with holder in accordance with an embodiment of the present invention;

FIGS. 2-3 depict top and bottom plan views, respectively, of the kinetically induced bracelet with holder in FIG. 1 having the unitary body thereof in an exemplary first position;

FIG. 4 depicts an elevational side view of the kinetically induced bracelet with holder in FIG. 1;

FIGS. 5-6 depict elevational front and rear views, respectively, of the kinetically induced bracelet with holder in FIG. 1;

FIG. 7 depicts a cross-sectional view of the kinetically induced bracelet with holder along section line 7-7 in FIG. 4;

FIG. 8 depicts a perspective view of an exemplary impetus applied to the unitary body in accordance with one embodiment of the present invention; and

FIG. 9 depicts a perspective view of the kinetically induced bracelet with holder in FIG. 1 having the unitary body thereof in an exemplary second position after the impetus has been applied.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms.

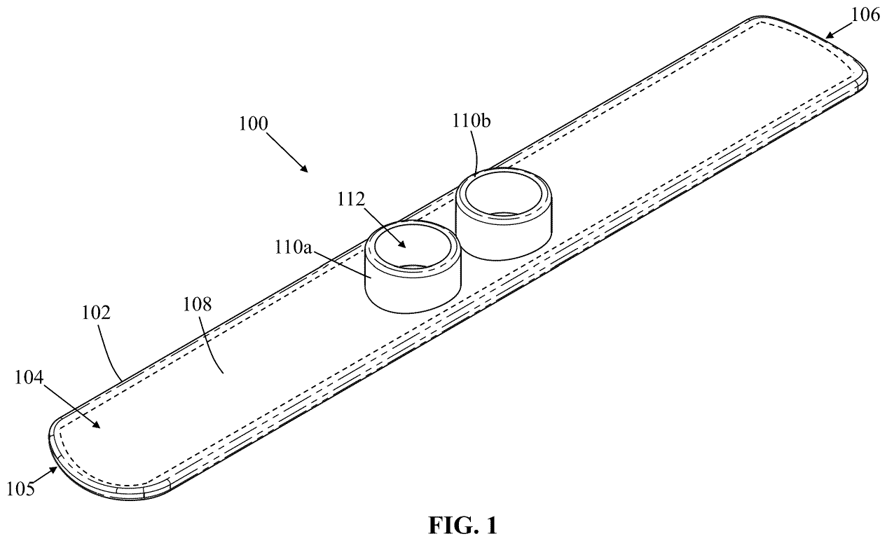

The present invention provides a novel and efficient kinetically induced bracelet with holder and method that addresses the aforementioned concerns in the art and permits user to effective, safely, and efficiently hold contents, e.g., prophylaxis paste containers, thereon for use by the user. Specifically, referring to FIG. 1 one embodiment of the present invention is shown in a perspective view. The figures herein show several advantageous features of the present invention, but, as will be described below, the invention can be provided in several shapes, sizes, combinations of features and components, and varying numbers and functions of the components.

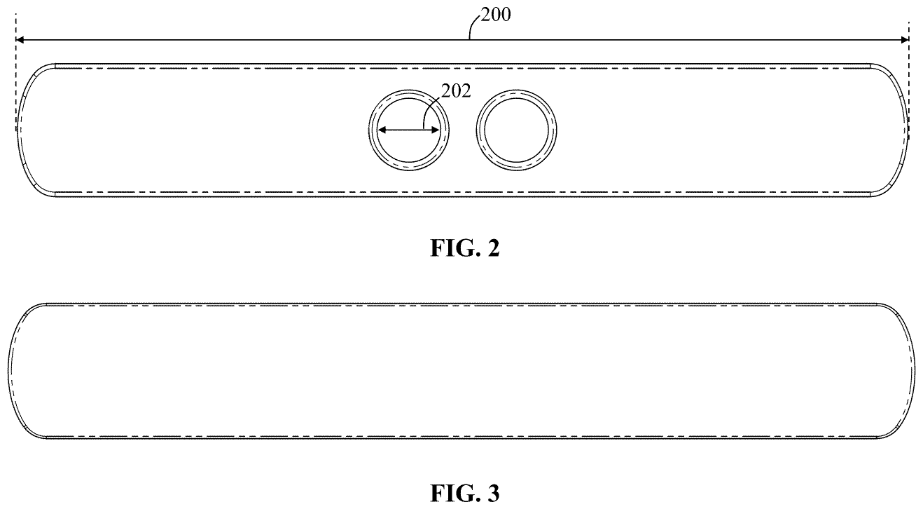

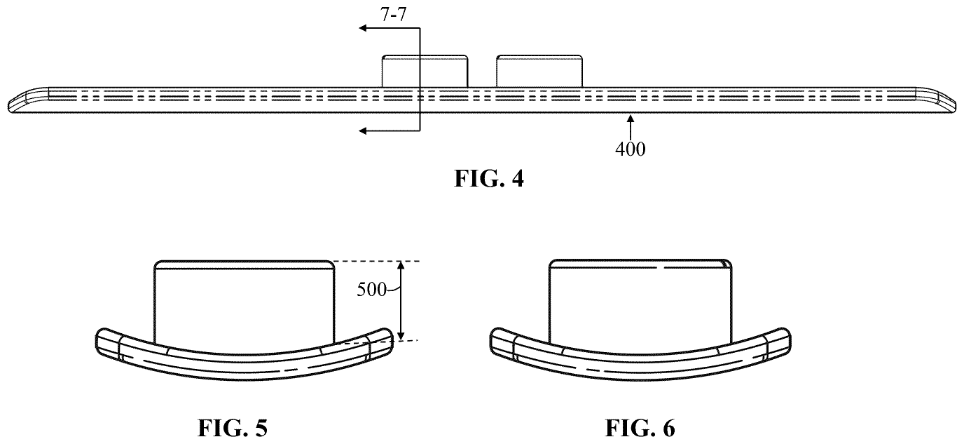

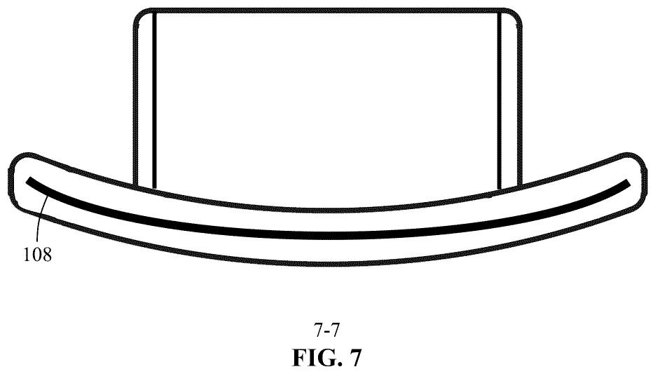

More specifically, with reference to FIGS. 1-2, the kinetically induced wrist bracelet with holder (generally referred to herein as “bracelet” 100) includes a unitary body 102 enabling it to move and be applied on as a single unit. The body 102 includes a first end 105 and a second end 106 opposing the first end 105 that are preferably the terminal ends of the bracelet 100 and that define a body length 200 separating the first and second ends 105, 106. The body length 200 is preferably of a range of approximately 6-10 in, but preferably is approximately 8 in.

Beneficially, the bracelet 100 includes an inner core 108 pre-formed formed in a stationary or inherent arcuate shape that is substantially thin and formed with a metallic material that enables the inner core 108 to snap from a completely concave orientation on one side to a completely convex orientation on that same side when subjected to an impetus (e.g., a driving external force). The body 102 also includes an outer layer 104 surrounding the inner core 700 and is also formed in an arcuate shape to contour the inner core 108.

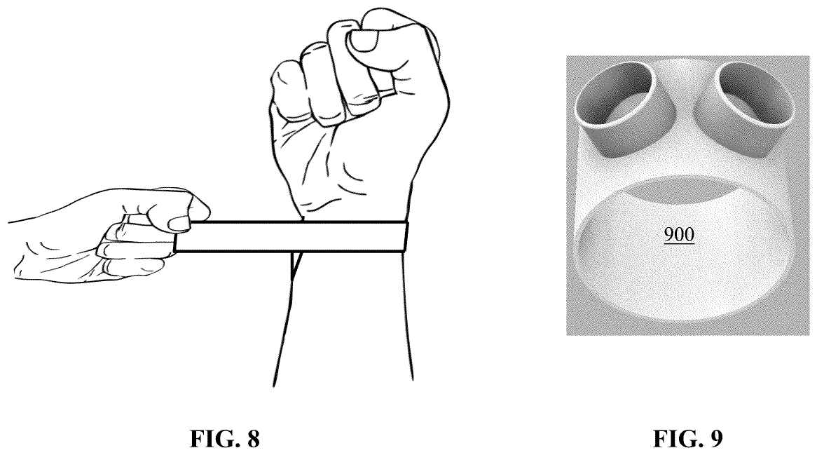

The inner core 108 span along the body length 200, but preferably substantially spans the body length 200 (i.e., spans approximately 95% or greater of the body length 200). The inner core 108 may be made of a monolithic and continuous metallic material formed in a narrow configuration. In one embodiment, the material is a flexible steel or aluminum that is capable of repeated (e.g., at least 500 occurrences) bending into various wearing positions (e.g., as shown in FIGS. 8-9) without material failure or plastic deformation. The inner core 108 preferably has an average and/or continuous thickness of approximately 0.007-0.02 in. (or an average or continuous thickness of approximately 0.3 mm) and average and/or continuous width of approximately 1-2 in. (or 30-33 mm) that is less than the body length 200. The inner core 108 material and configuration enables kinetic transformation of the unitary body 102 a first position (e.g., FIG. 1) to the second position (e.g., FIG. 9) that is worn by the user and conveniently places one or more holder sidewall(s) 110a-b easily accessible to the user. More specifically, the bracelet 100 is configured to have the one or more holder sidewall(s) 110a-b placed on the dorsal side of a user's wrist in an orientation that inhibits the contents retained by the sidewall(s) 110a-b from inadvertently being removed therefrom and still enabling quick and effective access thereto.

There are preferably two holder sidewalls 110a-b directly coupled to the outer layer 104 that research has shown enables effective use by a user, namely dental professionals, while still maintaining an orientation that does not inhibit the user's use of the bracelet 100. The two holder sidewalls 110a-b are coupled to the outer surface 104 in an adjacent configuration and spaced apart from one another within 1 in. The sidewall(s) 110a-b are disposed in an erect configuration relative to the outer layer 104 to define a cavity 112 shaped and sized to receive a selectively removable container therein (e.g., the prophylaxis paste container(s)). In particular, the one or more holder sidewall(s) 110a-b are disposed in a substantially perpendicular configuration (+/−) 5° relative to the outer layer 104 to enable the effective and efficient use described herein. The one or more holder sidewall(s) 110a-b are also preferably is enclosed to surround the cavity 112 so a user can place a viscous liquid or other contents desired to be used therein without it inadvertently being removed from the cavity 112. Preferably, the holder height 500 ranges from approximately 0.25-1 in. (or approximately 10 mm) the cavity 112 is a diameter 202 ranging from approximately 0.25-1 in (or approximately 15 mm). The one or more holder sidewall(s) 110a-b and cavities are preferably formed in a cylindrical shape to enable an erect configuration when placed in the various positions described herein.

In preferred embodiments, the outer layer 104 encapsulates the inner core 108 such that the outer layer 104 defines the terminal ends 105, 106 of the body 102. In preferred embodiments, the outer layer 104 is of a polymeric elastic material, e.g., a medical grade silicone, that facilitates in enabling the flexible repeated bending described herein. In one embodiment, the outer layer 104 and holder sidewall 110 are over-molded onto the inner core 108 to generate a low-cost product and to prevent failure at the joint between the holder sidewall 110 and the outer surface 104. The over-molding process is a manufacturing process that may include a multi-step injection molding technique where the outer layer 104 and holder sidewall 110 are molded directly over and around the inner core 108 to create a single integrated product with enhanced functionality and minimizing product failure with the aforementioned bending of the body 102 described herein.

In body 102 is also beneficially operably configured with an impetus to have a first position of a linear orientation (as exemplified in FIG. 1) including the one or more holder sidewall(s) 110a-b projecting outwardly from a concave surface on the arcuate shape of outer layer 104 and to have a second position of an annular orientation including the one or more holder sidewall(s) 110a-b projecting outwardly from a convex surface on the arcuate shape of the outer layer 104. Said another way, the linear orientation may include the entire inner core 108 and portions of the outer layer 104 covering the inner core 108 in a linear orientation, wherein once the impetus is applied onto the body 102, namely the convex side of the outer surface 104 when in the first position (as indicated with arrow 400 in FIG. 4). The application of the impetus causes the unitary body 102 to start curling or forming the annular shape (exemplified in FIG. 8).

The desired second position is exemplified in FIG. 9, wherein the concave surface in the first position with the holder sidewalls 110a-b thereon has not become the convex surface placing the sidewalls 110a-b advantageously configured thereon. The elastic material of the sidewalls(s) 110a-b enables quick and effective retention of containers and cleaning of the product, wherein the sidewalls 110a-b may be flexed and generate an inherent compressive force on said containers. The second position advantageously defines an area 900 for placement of a user's wrist that may be advantageously selectively modified for a desired thickness of a user's wrist. The user may then return the body 102 to the first position by bending the product near each end 105, 106 to make it linear in shape.

Although a specific order of executing utilization steps has been disclosed and depicted in the drawings, the order of executing the steps may be changed relative to the order shown in certain embodiments. Also, two or more steps shown or described as occurring in succession may be executed concurrently or with partial concurrence in some embodiments. Certain steps may also be omitted for the sake of brevity. In some embodiments, some or all of the process steps can be combined into a single process.

Various modifications and additions can be made to the exemplary embodiments discussed without departing from the scope of the present disclosure. For example, while the embodiments described above refer to particular features, the scope of this disclosure also includes embodiments having different combinations of features and embodiments that do not include all of the above-described features.

What is claimed is:

1. A kinetically induced wrist bracelet with holder comprising:
a unitary body having a first end, having a second end opposing the first end, defining a body length separating the first and second ends, having an inner core of an arcuate shape spanning along the body length, having an outer layer surrounding the inner core, forming an arcuate shape, and spanning along the body length, having at least one holder sidewall directly coupled to the outer layer and disposed in an erect configuration relative to the outer layer to define a cavity shaped and sized to receive a selectively removable container therein, and operably configured with an impetus to have a first position of a linear orientation including the at least one holder sidewall projecting outwardly from a concave surface on the arcuate shape of outer layer and have a second position of an annular orientation including the at least one holder sidewall projecting outwardly from a convex surface on the arcuate shape of the outer layer.

2. The kinetically induced wrist bracelet with holder according to claim 1, wherein the accurate inner core spans at least 90% of the body length.

3. The kinetically induced wrist bracelet with holder according to claim 1, wherein the outer layer encapsulates the inner core.

4. The kinetically induced wrist bracelet with holder according to claim 3, wherein the outer layer is of a polymeric material.

5. The kinetically induced wrist bracelet with holder according to claim 4, wherein the outer layer and holder sidewall are over-molded onto the inner core.

6. The kinetically induced wrist bracelet with holder according to claim 4, wherein the inner core is of a monolithic and continuous metallic material formed in a narrow configuration.

7. The kinetically induced wrist bracelet with holder according to claim 1, wherein the at least one holder sidewall is disposed in a substantially perpendicular configuration (+/−) 5° relative to the outer layer.

8. The kinetically induced wrist bracelet with holder according to claim 7, wherein the at least one holder sidewall is enclosed to surround the cavity.

9. The kinetically induced wrist bracelet with holder according to claim 8, wherein the outer layer and the at least one sidewall are of a polymeric elastic material.

10. The kinetically induced wrist bracelet with holder according to claim 9, wherein the outer layer encapsulates the inner core.

11. The kinetically induced wrist bracelet with holder according to claim 10, wherein the outer layer and holder sidewall are over-molded onto the inner core.

12. The kinetically induced wrist bracelet with holder according to claim 1, wherein the erect configuration of the at least one holder sidewall further defines:
a holder height ranging from 0.25-1 in., the at least one holder sidewall enclosing the cavity.

13. The kinetically induced wrist bracelet with holder according to claim 12, wherein the cavity is a diameter ranging from 0.25-1 in.

14. The kinetically induced wrist bracelet with holder according to claim 13, further comprising:
two holder sidewalls coupled to the outer surface in an adjacent configuration and spaced apart from one another within 1 in.

15. The kinetically induced wrist bracelet with holder according to claim 1, further comprising:
two holder sidewalls coupled to the outer surface in an adjacent configuration and spaced apart from one another within 1 in.

16. The kinetically induced wrist bracelet with holder according to claim 15, wherein the outer layer and holder sidewall are over-molded onto the inner core.
